(19) United States
(12) Patent Application Publication
(10) Pub. No.: US 2010/0163748 A1
(43) Pub. Date: Jul. 1, 2010

(54) DUAL DETECTOR CAPILLARY WAVEGUIDE BIOSENSOR AND METHOD FOR USE THEREOF

(76) Inventor: Harbans S. Dhadwal, Stony Brook, NY (US)

Correspondence Address: THE FARRELL LAW FIRM, LLP, 290 Broadhollow Road, Suite 210E, Melville, NY, 11747, US

(21) Appl. No.: 12/601,467

(22) PCT Filed: May 23, 2008
(86) PCT No.: PCT/US2008/064650

§ 371 Date: Nov. 23, 2009

Related U.S. Application Data
(60) Provisional application No. 60/939,899, filed on May 24, 2007.
(60) Provisional application No. 61/055,231, filed on May 22, 2008.

(51) Int. Cl. G01N 21/64; G01J 1/58; G01N 21/47

(52) U.S. Cl. 250/459.1; 356/338; 250/458.1

(57) ABSTRACT

A method for fluorescence detection that provides control of experimental and molecular factors and reliably predicts of concentration from fluorescence intensity measurements utilizing capillary-based flow sensors utilizing a dual detector approach to provide instantaneous normalization of the fluorescent intensity by the Rayleigh scattered intensity measured from the same sensing volume, insensitive to various experimental parameters for prediction of absolute concentrations of fluorescent solutes.

### PRIORITY

This application claims priority to U.S. Provisional Application No. 60/939,899, filed May 24, 2007, and to U.S. Provisional Application No. 61/055,231, filed May 22, 2008, the contents of each of which is incorporated herein by reference.

### GOVERNMENT SUPPORT

This invention was made with government support under grant number OCE-0352252, OCE-0083193, OCE-9907983 awarded by the National Science Foundation. The government has certain rights in the invention.

### BACKGROUND OF THE INVENTION

1. Field of the Invention

The present invention relates to use of a dual detector capillary waveguide biosensor for fluorescence detection and quantification of a hybridized target and other uses.

2. Brief Description of the Background Art

Fluorescence detection is a highly sensitive analytical technique for the detection of solutes at low concentration. However, the technique typically lacks the control of experimental and molecular factors that is essential for the reliable prediction of concentration from fluorescence intensity measurements. Capillary-based flow sensors are particularly sensitive to changes in the microenvironment within the sensing volume.

Fluorescence based detection schemes are among the most sensitive analytical techniques for applications ranging from enhanced visualization in fluorescence microscopy, to DNA sequencing and bio/chemical sensing [See, Taitt, et al., Biosens. Bioelectron. 20 (2005) 2470, K. R. Rogers, Anal. Chim. Acta, 568 (2006) 222], including sensors based on hybridization between a single-stranded nucleic acid “probe” and the nucleic acid “target” to be detected. The specificity of hybridization is controlled by well-established procedures, e.g. by adjusting probe sequence length. The probe is typically immobilized on a substrate, for example, an optical fiber or a planar waveguide [See, Bemini, et al., IEEE Sens. J. 6 (2006) 1218, Mastichiadis, et al., Anal. Chem. 74 (2002) 6064, Thrush, et al., Sensor. Actuator. B-Chem. 150 (2005) 393, A. Lucotti, et al., Sensor. Actuator. B-Chem. 121 (2007) 356, Leistiko, et al., J. Micromech. Microeng. 8 (1998) 148].

In fluorescence-based hybridization sensors, target sequences are detected after hybridization to the surface-bound probe molecules. Depending on the strategy employed. hybridization can result in either an increase or a decrease in fluorescence relative to a zero-hybridization background level. Subsequent to detection, the probe-target hybrids are denatured by chemical means or through the use of elevated temperatures, allowing the sensor to be recycled for many hybridization/detection cycles. For natural samples, e.g. seawater, detection strategies can include competitive /or complementary hybridization protocols [See, Wang, et al., BioTechniques. 32 (2002) 1342; Medina-Sanchez, et al., Appl. Environ. Microb. 71 (2005) 7321; Ahn, et al., Appl. Environ. Microb. 72, (2006) 5742], or the use of molecular beacon probes that fluoresce upon hybridization [See, Lenaerts, et al., Appl. Environ. Microb. 73 (2007) 2020].

Detection of a hybridization event is achieved when the measured fluorescent intensity goes outside the bounds of a defined zero-hybridization threshold condition. This is a much less challenging problem than achieving absolute concentration measurements based on fluorescence intensity. Many experimental parameters cannot be reproduced between measurements taken at different times; i.e. the concentration versus fluorescence calibration curve is likely to change between uses of an instrument. Even in a perfect instrument, the quantum yield of different batches of the same dye will result in variation of fluorescent intensity that is unrelated to concentration. Such problems are severe obstacles to meaningful comparisons of data coming out of different research laboratories. In response, NIST researchers [See Gaigalas, et al., J. Res. Natl. Inst. Stan. 106, 2, (2001) 381] proposed the development of standard reference materials (SRMs) that could be used to inter-calibrate instruments and laboratories. However, SRMs are most useful when the same instrument is being used by different laboratories and measurements are relatively insensitive to experimental parameters.

NIST researchers have also recommended the adoption of a universal measure of fluorescence intensity referred to as MESF (molecules of equivalent soluble fluorophore), and MESF-based SRMs have been used for many years. [See, Kemp, et al., Appl. Environ. Microb. 59 (193) 2594] However, the use of MESF standard reference materials requires adherence to strict experimental controls, specifically: 1) the measurements of the standard and the test solution must be performed in the same instrument; 2) the excitation spectrum of the fluorophores in the standard and test solution should match; and 3) the emission spectrum of the fluorophores in the standard and test solution should match.

Although SRMs have found widespread acceptance in such popular instruments as a flow cytometer, SRM materials are not particularly useful for other types of fluorescence sensors, including Capillary Waveguide Biosensors (CWB). The latter type are subject to larger variability in experimental factors, in part because of the many optical interfaces. Furthermore, while continuous flow is possible in a hybridization-based instrument, it is wasteful of sample materials, which are often both scarce and expensive to obtain. Consequently, stop-flow protocols are employed to achieve low-volume hybridizations with minimal sample loss per hybridization. In this interrupted flow regime, micro-bubbles are unavoidable and can have a deleterious affect on data reproducibility. [See, Dhadwal, et al., Anal. Chim. Acta. 501 (2004) 205.] For example, the intensity of the evanescent wave illuminating a region of the immobilized probe on the inner surface of the capillary is dependent on the mode field distribution inside the capillary wall and therefore is highly affected by micro-bubbles. MESF based SRMs are not useful when the microenvironment within the instrument is variable.

Despite the many challenges facing CWB developers, a CWB has been described which used the interior region of a capillary both as a hybridization reaction chamber and an optical waveguide [See, Dhadwal, et al., Anal. Chim. Acta. 501 (2004) 205], showing that such a sensor could be recycled many times and had a minimum detectable concentration of 30 pg ml⁻¹. However, the fluorescence intensity measurements could not be used to reliably estimate the concentration of target in unknown samples. The present invention provides a dual detector approach for increasing the reliability of concentration estimates obtained from fluorescent intensity.

### SUMMARY OF THE INVENTION

The present invention provides a novel dual detector approach for instantaneous normalization of the fluorescent intensity by the Rayleigh scattered intensity measured from the same sensing volume. The normalized data are insensitive to various experimental parameters and can be used to predict absolute concentrations of fluorescent solutes. A fully automated capillary waveguide biosensor of the present invention is based on nucleic acid hybridization and uses the dual detector approach.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1(a) depicts ideal geometry for fluorescence detection;

FIG. 1(b) depicts CWS geometry of F—fluorescent photons and R—Rayleigh scattered photons;

FIG. 2 is a schematic of a Capillary Waveguide Biosensor (CWB);

FIG. 3 is a schematic of an electronics module controlling the CWB;

FIG. 4 is a typical single run sensor output;

FIG. 5 provides a summary of fluorescent intensity data for the hybridization buffer;

FIG. 6 shows a typical measurement over a range of dye concentrations;

FIG. 7 shows concentration calibration for three opto/fluid connectors;

FIG. 8 provides a summary of hybridization kinetics using different concentrations of synthetic target;

FIG. 9 shows a CWB saturation signal and time constants for synthetic target;

FIG. 10 shows a dual photomultiplier scheme for fluorescent detection of the present invention;

FIG. 11 shows excitation geometry for direct wave illumination of surface bound molecules; and

FIG. 12 shows excitation geometry for evanescent wave illumination of surface bound molecules.

### DETAILED DESCRIPTION OF THE PREFERRED EMBODIMENTS

The following detailed description of preferred embodiments of the invention will be made in reference to the accompanying drawings. In describing the invention, explanation about related functions or constructions known in the art are omitted for the sake of clearness in understanding the concept of the invention, to avoid obscuring the invention with unnecessary detail.

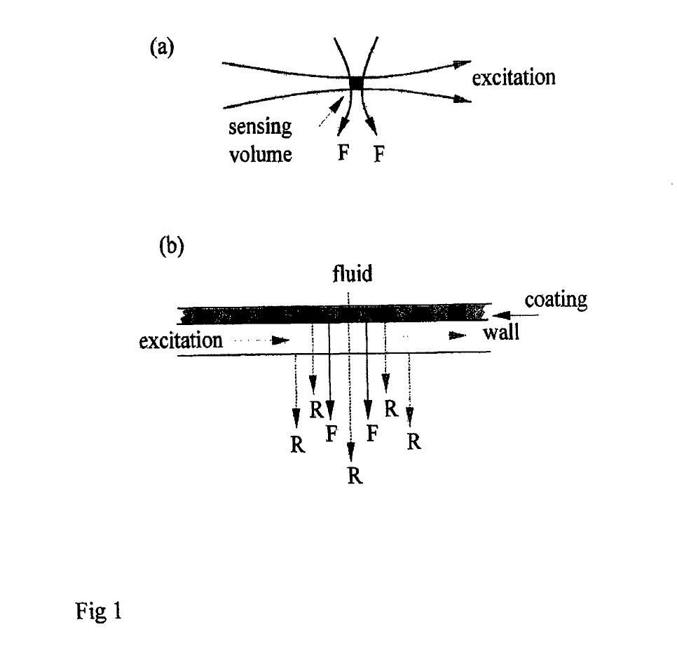

The following theoretical considerations are to be observed. The ideal fluorescence experiment described by Gaigalas et al. is depicted in FIG. 1a. Using the arguments of Gaigalas et al. it is possible to estimate the fluorescent intensity (photon flux) in term of experimental and molecular parameters. If a single photon detector is illuminated by the fluorescent photon flux emanating from the sensing volume then the average number of fluorescent photon counts [symbol] n_{F} [symbol] in time interval T is given by Equation (1):

$$〈 {n}_{F} 〉 = T [ {\int }_{λ} {Φ}_{F} ( λ ) Q ( λ ) d λ ] \qquad ( 1 )$$

where Q(λ) is the quantum efficiency of a photodetector, for example, a photomultiplier (PMT). The fluorescent flux per unit wavelength per second Φ_{F}(λ), is given by Equation (2):

$${Φ}_{F} ( λ ) = ɛ c φ ( λ ) R ( λ ) {\int }_{v} {I}_{o} ( r ) Ω ( r ) d r \qquad ( 2 )$$

where the integral is carried out over the sensing volume v, ε is the molar extinction coefficient (m².mol⁻¹) at the excitation wavelength, c is the concentration of the fluorophore (mol.L⁻¹), φ(λ) is the probability per wavelength of emitting a photon at λ. Iₒ(r) is the photon flux (m⁻²s⁻¹) at r, R(λ)Ω(r) is the probability that a photon emitted at r will arrive at the PMT photocathode. It is assumed that the filter characteristics are the same for all paths through the collection optics. The factor R(λ) defines the wavelength response of the various optical filters that separate the excitation component of the collected photon stream. The factor Ω(r) represents the spatial properties of the collection optics. Combining equations (1) and (2) gives the fluorescence response of for the ideal instrument, as in Equation (3):

$$〈 {n}_{F} 〉 = T [ {ɛφ}_{o} Ω {\int }_{λ} Q ( λ ) R ( λ ) s ( λ ) d λ ] c \qquad ( 3 )$$

where φ(λ) can be written as a product of the quantum yield φₒ and a normalized spectral function s(λ). The optical geometry factor Ω is defined by Equation (4):

$$Ω ≡ {\int }_{v} {I}_{o} ( r ) Ω ( r ) d r \qquad ( 4 )$$

Equation (3) shows that the fluorescent intensity counts are proportional to the integration time T and the sample concentration c. The quantity in the square brackets corresponds to the slope of the concentration series. It should be noted that slope is a function of both the instrumental factors [Q(λ), R(λ) and and molecular factors Ω] and molecular factors [ε, φₒ and s(λ)]. In order to obtain reliable fluorescent intensity measurements across different instruments or from repeated measurements with the same instrument, these factors must either be eliminated from consideration or be controlled with an appropriate calibration coefficient for instrument-independent measurements.

Gaigalas et al. eliminated the consideration of these parameters by proposing the development of a set of standard solutions for use with identical instruments. Thus, for a particular instrument, the concentration of the test solution can be expressed as a ratio of the fluorescent counts for the test and standard solutions. The concentration of the test solution is expressed in. MESF units. This protocol was developed with respect to the use of flow cytometers, which can be operated close to the ideal experimental conditions. Despite this, the measurements of fluorescent intensity in terms of MESF units still have problems, as most fluorescence based instruments cannot be guaranteed to operate under the same conditions from to day to day. In particular, fluorescence sensors such as the CWB described by Dhadwal et al. fall into this category of non-ideal field instruments, in which ideal behavior is traded for small, sensitive and portable design suitable for field applications.

FIG. 1(b) illustrates the optical geometry for the CWB. It is apparent that the geometrical factor Ω is far more complex than that of the ideal experiment. Specifically, the photons emanating from the sensing volume encounter three optical interfaces before being separated into the fluorescent and Rayleigh scattered components. The three interfaces are: 1) the fluid/coating; 2) the coating/capillary wall and 3) the capillary wall/air. On the excitation side, Iₒ(r) is determined by the combined illumination arising from the evanescent wave field and the higher order, weakly guided modes in the interior region of the capillary. The former is strongly dependent on the properties of the three layer optical waveguide. Essentially, the strength and penetration depth of the evanescent wave field is a function of the modal distribution inside the wall of the capillary. The evanescent wave field can be influenced by small perturbations in the waveguide parameters. For example, the appearance of micro-bubbles at the coating/fluid interface can have a strong affect on the excitation intensity. The source of the micro-bubbles is not easily identified and due to its random nature is difficult to control reliably. Thus, the factor Ω in equation (3) is subject to erratic behavior for CWB systems, presenting a serious problem for obtaining consistent measurements of concentration of fluorophores based on absolute fluorescent intensity. In general, the factor Ω can fluctuate during a single measurement, or between a series of repetitive measurements for the same sample. Consequently, absolute comparisons between data taken at different times are confounded by the random nature of these fluctuations.

Even in a well-behaved, idealized fluorescence experiment, the photon flux emanating from the sensing volume contains both fluorescent photons and scattered photons (Rayleigh scattering). [See, Wang, et al., J. Chromatogr. A. 1062 (2005) 274.] Typically, the former component is separated through the use of optical filters described by R(λ). In general, optical filtering has to be very selective in order to extract the fluorescent emission at low concentrations of fluorophores. State-of-art systems boast a detection limit of a few pg ml⁻¹, but the reproducibility, due to the factors discussed above, is very poor. In principle, the random intensity fluctuations may be eliminated by normalizing the fluorescent intensity by an independent measure of the Rayleigh scattered background form the same sensing volume.

The present invention describes a novel dual detector technique which substantially increases the reproducibility of the solute concentration estimates. In the present invention, the two components of the photon stream are measured using independent photodetectors. As discussed above, one photomultiplier (PMT) measures the time average estimate of the fluorescent intensity, while the second PMT measures the photon counts due to the Rayleigh scattering background from the same sensing volume. The average number of photons due to Rayleigh scattering is provided in Equation (5):

[symbol]

n_{R} [symbol] =τTΩ (5)

where τ is an attenuation factor of a neutral density filter placed in front of the PMT. The outputs of the two PMTs are combined to yield an instantaneous normalization of the fluorescent counts given by Equation (6):

$${N}_{F} ( t ) = \frac{〈 {n}_{F} ( t ) 〉}{〈 {n}_{R} ( t ) 〉} = \frac{1}{τ} [ {ɛφ}_{o} {\int }_{λ} Q ( λ ) T ( λ ) s ( λ ) d λ ] c \qquad ( 6 )$$

Equation (6) shows that the dual PMT detection scheme eliminates the Ω dependence from the measurements. Any variable molecular factors still need to be controlled, and this approach will be recognized to be valuable in conventional fluorescence experiments.

Implementation and instrumentation for implementing the scheme of the present invention in an automated capillary waveguide biosensor is described below.

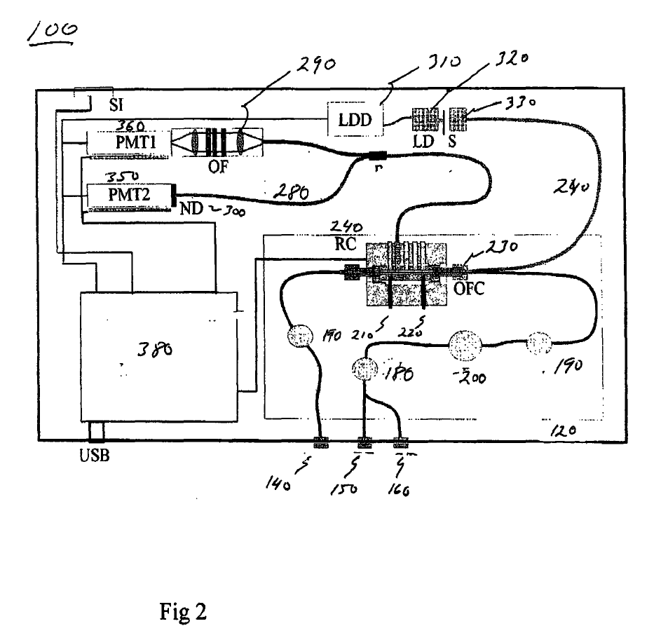

A CWB described by Dhadwal et al. demonstrated that a hybridization reaction could be carried out in the interior region of a coated capillary. The sensor could be recycled many times after denaturing with formamide. A fully automated CWB of the present invention that includes the dual detector approach discussed above, is shown diagrammatically in FIG. 2. The system is composed of four sub-systems: 1) optical excitation and detection; 2) fluid control; 3) an electronics module; and 4) a graphical user interface (GUI) running on the host computer.

FIG. 2 shows an apparatus 100 for use of the Capillary Waveguide Biosensors, including front panel 120, a waste port 140 for the fluid sample, a fluid port 150 for the denature solution, a Sample/Buffer port 160 for the sample and buffer, which in a preferred embodiment can be connected to a carousel dip probe, a 3-way (i.e. multi-directional) pinch valve 180, isolation valves 190, a micro-pump 200, resistance thermistors 210 and 220, and an opto/fluid connector 230, a CWB housing, an illuminating optical fiber 240, a one mm emission pick-up fiber 250, a power splitter 260, a one mm fiber 270, a 110/140 micron fiber 280, an optical emission filter set 290, a neutral density filter 300, a laser diode driver 310, a laser diode 320, a shutter 330, an optical coupler (not shown), photomultipliers 350 and 360, control relays 380, a USB port 390, and a carousel interface connector (not shown). In a preferred embodiment, the CWB of the present invention is operated in a fully automated manner, and additional may be coupled to a carousel type handling system for analyze a plurality of samples.

Optical excitation and detection is preferably as follows. Excitation of the immobilized hybridized complex on the interior surface of the capillary is achieved through an opto-fluid connector (OFC) described by Dhadwal et al. Essentially, an optical connector (Amphenol #SMA 905) is modified to provide a fluid port in the central region, and a single or multiple fibers in the periphery of the connector for optical excitation and/or emission collection. Fluorophore molecules on the capillary wall coating or in the fluid stream can be illuminated directly by the weakly guided modes in the interior region of the fluid filled capillary, or indirectly by an evanescent wave field arising from the guided modes in the wall of the capillary. In order to implement the first method of excitation opto/fluid connector 210, is used in which the transmitting optical fiber 240, is aligned parallel to the optical axis and illuminates the interior region of the capillary. Alternative connector configurations (e.g. 210) position the transmitting fiber such that there is overlap with the capillary wall. Transmitting fiber 210 preferably uses a 110/140 micron fiber whose dimensions are closely matched to capillary wall thickness of 150 microns, while an other alternate connector (not shown in FIG. 2) uses a 300/330 micron fiber such that some of the fiber core is also in contact with the fluid. Transmitting fiber 210 exclusively excites the modes in the capillary wall, while illumination from the other alternate connector includes additional excitation of some of the higher order, weakly guided modes in the interior region of the capillary.

An orthogonal geometry, which provides significant separation of the excitation source from the fluorescence emission, is used for capturing the photons emanating from the sensing volume. A one millimeter fiber, 250, with a numerical aperture of 0.48 (Thorlabs #URT1000) collects all of the emission emanating from the capillary surface. Power splitter, PS, pipes most of the photons into a second one millimeter fiber, F3, which transports the photons, through collimating optics, a holographic notch filter (Kaiser #HNPF) and a band-pass emission filter (Omega Filters XF3074), OF, to a PMT (Hamamatsu model #H9305-04). Overall the out-of band rejection is better than 10⁻⁵. The second port of the power splitter is a 110/140 micron optical fiber 280, which guides the photons through the neutral density filter 300, to second PMT2, which provides the instantaneous photon counts corresponding to the Rayleigh scatter from the sample and the various optical interfaces.

A DPSS laser, LD, (Photop Technologies model#GDL7020) is preferably used for excitation of the Alexa 532 fluorophore used in the experiments reported here. The laser has a peak emission wavelength of 532 nm with a FWHM spectral width of 5 nm and delivers 15 mW of optical power. The laser is coupled into the transmitting fiber 240 utilizing a cylindrical gradient index lens (not shown). In most cases excitation power is less than 1 mW. In order prevent laser exposure during hybridization and minimize photobleaching, an electro/mechanical shutter 330 is activated only during measurement. Direct current modulation could not be used due to the warm up time required for this type of laser. Even after warm-up, the second-harmonic generation lasers, in the absence of active cooling, usually exhibit power fluctuations of about 20%.

In a preferred embodiment of the present invention, a fluid control system is provided for rapid mounting of the coated capillary tubes. A silica capillary tube (Polymicro Technologies #1.0/1.3 mm) is cut to a length of 65 mm and the two ends are mounted into half-inch diameter stainless steel sleeves. The ends are polished for optical flatness and, as discussed below, the capillary is subsequently processed for immobilizing probes on the interior surface. The capillary is easily mounted into a temperature-controlled housing, RC, made from copper and surrounded by an insulating shell made from black nylon thermoplastic. The capillary is held in place utilizing SMA 905 optical connectors at either end of the housing, to provide simultaneous fluid and optical access to the capillary.

Typically, several different fluids need to be pumped through the capillary during a hybridization cycle. Fluid flow is managed by a diaphragm micro-pump, P, (Bio-Chem #120SP112), two solenoid isolation valves, 190, (Bio-Chem #075T2NC12), and the 3-way pinch value 180 (Bio-Chem #075P3MP12). These fluid control devices are individually addressed through the GUI, which preferably offers two modes of operation: manual and batch. The manual mode allows for full control of the fluid flow stream, while the batch mode enables unattended operation for processing twelve test samples. A carousel, with rotational and up-down stepper motors, uses a dip probe to access fluid in any of twenty-four 5 mL round vials. A preferred embodiment allows the user to program the CWB for unattended operation.

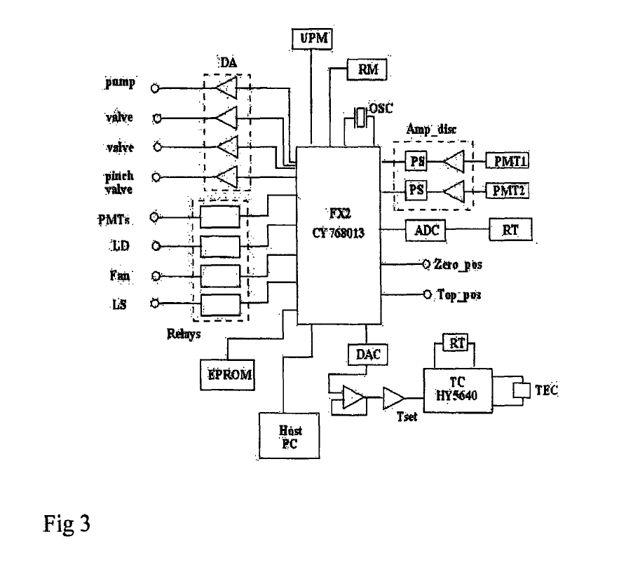

The present invention also includes in a preferred embodiment an electronics module. FIG. 3 shows a block schematic of the electronics module of the CWB. The entire control and data acquisition is preferably designed around the Cypress FX2 (C67C68013), which integrates the USB 2.0 transceiver, SIE, enhanced 8051 micro-controller, and a programmable peripheral interface into a single chip. This is a very cost-effective solution that shortens development time and provides a small foot print for use in a mobile platform.

Four high current relays (NEC #PS170A) are used to power up the PMTs, the laser diode, an optional fan for the temperature controller and the laser shutter. The 8051 generates the timing pulses for operating the self priming micro-pump, two isolation valves, and the 3-way pinch valve. External Darlington amplifiers, DA (Texas Instruments # ULN2003A), provide the current necessary to drive the pump and the valves. Batch operation requires the use of a carousel and a dip probe. The position and height of the dip probe are controlled by a motor, RM, (Pik Power #SST42D1020) and the linear actuator, UPM, (Herbach & Rademan #TM96MTR2873), both are powered directly from the FX2, via the 8051. Two optoelectronic interrupt switches provide the zero angle reference and the top of the fluid limit.

Temperature control of the fluid inside the capillary is attained through the use of a TEC (Melcor #CP1) heat exchanger using an analog controller from Hytek Devices (HY5640), which drives the current in a bipolar direction through the series of PN junctions until the set temperature is obtained. A sensing NTC thermistor, RTS, (Betatherm #10K3A11A) provides the requisite feedback. The operating temperature, in the range of 15° C. to 65° C. is set by the user from the ail application. A 8-bit digital-to-analog (Maxim 7545) converter inside the FX2 creates an analog voltage corresponding to the thermistor look-up table. A combination of an amplifier and transistor provide an active emulation of the set resistor, Tset, required by the Hytek controller, which uses proportional/integral control to attain temperature stability of 0.01° C. However, due to the 8-bit digital-to-analog converter, the actual temperature stability is about 0.5° C. A second thermistor, RTM, provides an actual measurement of the fluid temperature. The thermistor resistance is converted to a voltage drop, which is converted to a 8-bit digital data by the analog-to-digital converter (Maxim 153). The GUI interprets the 8-bit word through another look-up table for continuous update of the fluid temperature display.

The graphical user interface (GUI) of a preferred embodiment of the present invention is preferably designed to run on a Windows XP platform and is written in Visual C++. The GUI is used for the entire control of the instrument, including data logging, real time displays and post measurement playback feature to process archived data files. The sensor is controlled through a USB2.0 serial data interface. During normal operation three windows display the instantaneous count values of the Rayleigh signal, the fluorescent signal and the normalized signal. A fourth window displays the fluid temperature inside the capillary.

Background of laser illumination of multiple capillaries that form a waveguide are provided in U.S. Pat. No. 5,790,727, the contents of which is incorporated herein by reference. Background of a capillary waveguide fluorescence sensor are provided in U.S. Pat. No. 6,850,657, the contents of which is incorporated herein by reference. Background of dynamic light scattering techniques are provided in U.S. Pat. Nos. 5,155,549 and 4,983,040, the contents of which is incorporated herein by reference. Background of an apparatus for submicron particle sizing and a probe for such are provided in U.S. Pat. No. 5,815,611, the contents of which is incorporated herein by reference.

The Operation of the CWB of a preferred embodiment of the present invention is as follows. In a first series of experiments the efficacy of the normalization technique described above was investigated using an uncoated capillary and various concentrations of the Alex532 fluorophore diluted in a hybridization buffer, whose composition is described in the following section. The alternative opto/fluid connector described above was used as the illuminator, with optical power of 0.6 mW emanating from the distal end of the fiber. In a typical run, a capillary was mounted into the CWB and loaded with the sample under test. A single measurement was taken over a time interval of 30 to 60 seconds, with data recorded every second. The single measurement can be repeated by reloading the sample. Thus, each run includes a series of measurement cycles. A new run is initiated with the re-mounting of the capillary and the opto/fluid connector. The measurement sequence was as follows: purge air to empty capillary; load 2 ml sample into the capillary; wait 60-120 seconds for fluid to reach set temperature; open the shutter for 30 seconds to acquire data.

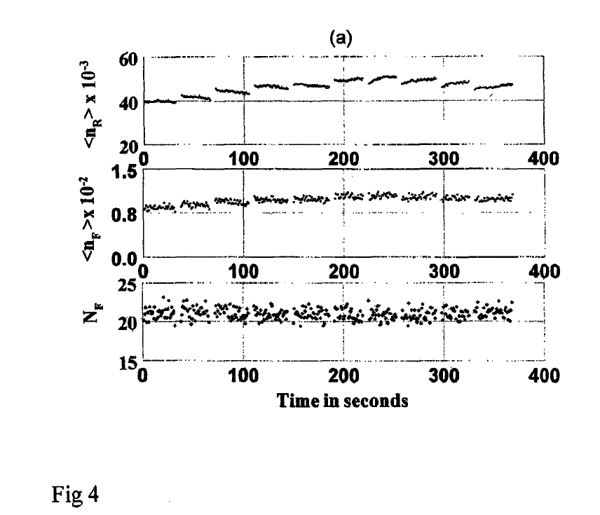

FIG. 4 shows measurements for one run of the uncoated capillary, which was re-loaded with the hybridization buffer before each cycle. The three traces represent, the Rayleigh scattered counts. the fluorescent counts and the normalized counts, respectively. The cycle to cycle value of normalized fluorescent intensity shows a reduced variation compared with the raw fluorescent signal. However, on occasions, the Rayleigh scattered counts will increase sharply, while the raw fluorescent counts do not follow, resulting in erroneous normalization. The source of the sharp changes in the Rayleigh scattered could not be isolated but it is conjectured to arise from the spontaneous generation of micro-bubbles in the field of view of the one mm collection fiber. However, this event is infrequent and easily detected.

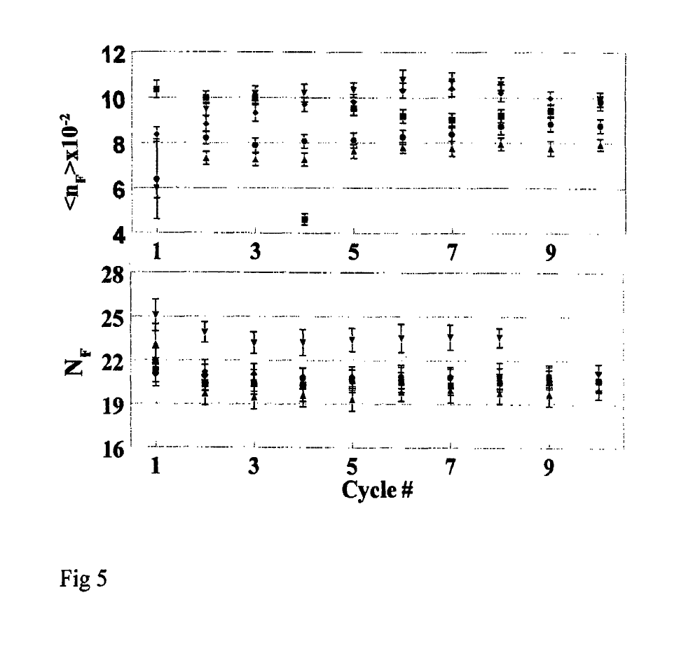

FIG. 5 provides a summary of fluorescent intensity data taken with a hybridization buffer. In FIG. 5, five separate runs are indicated by different symbols. Each data point is the average of 30 points per cycle. In order to assess the overall benefit of the dual detector technique, five different runs were performed. The following conclusions can be drawn from the data. First, the average signal-to-noise ratio of each thirty second measurement is 27.1 and 27.7 for the raw and normalized fluorescent data, respectively. This is an indication of the system stability during the thirty second interval and is expected to be the same for both measurements. Second, the relative deviation in the average value of the counts between cycles in one run is 12.6% and 6.7% for the raw and normalized fluorescent signals, respectively. Finally, the relative deviation between the cycles taken over the five runs is 17.9% and 6.3% for the raw and normalized estimates, respectively. These figures clearly confirm that instantaneous normalization, as discussed above, gives a significant improvement in the efficacy of the fluorescent intensity data acquired with the dual detector approach.

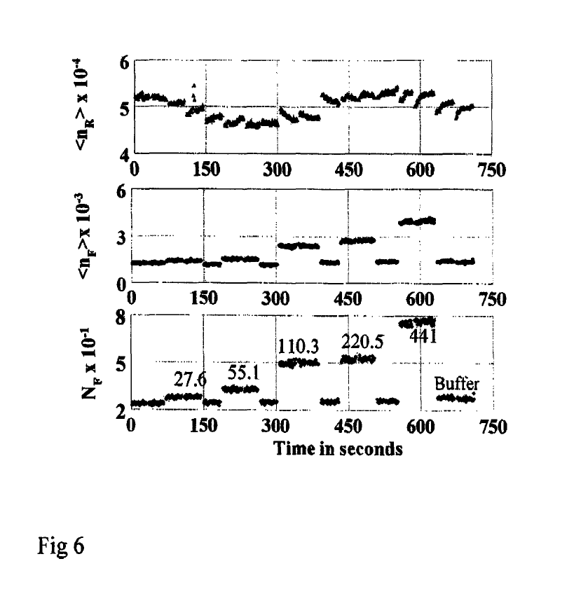

Sensitivity of the CWB was tested by using a set of diluted Alex532 fluorophore solutions. FIG. 6 shows the results of a typical run, which includes a sequence of measurements of the various concentrations interlaced with measurements of the buffer. In FIG. 6, measurement is made over a range of dye concentrations (pg ml⁻¹), with a lower panel labeled with the concentrations in pg ml⁻¹. The lowest concentration of 27.6 pg ml⁻¹ (˜3×10⁻¹² M) is clearly detectable. At each concentration the solution was loaded twice, giving two thirty second independent measurements. The concentration series was repeated three times, for each of the opto/fluid connectors T1, T2 and T3.

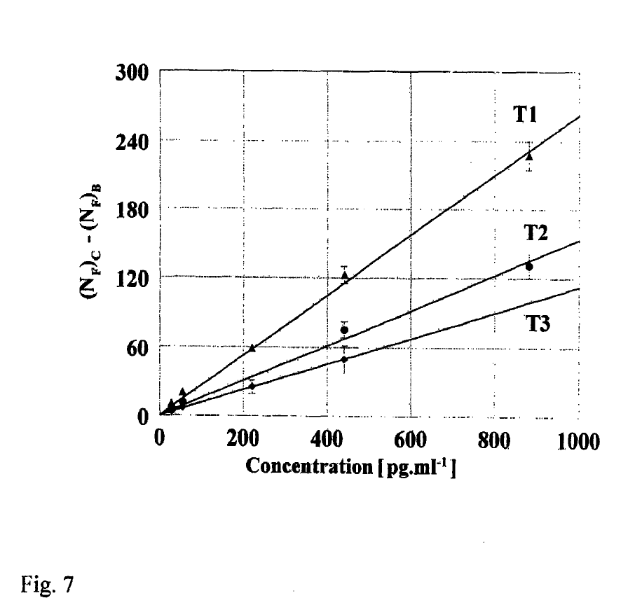

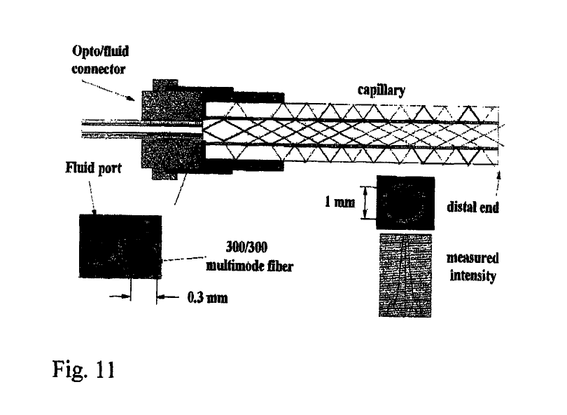

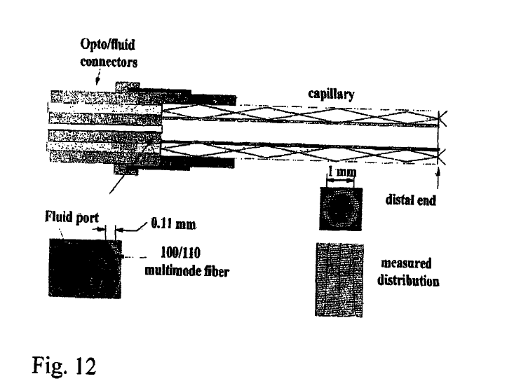

FIG. 7 shows a concentration series summarizing the above results, showing a concentration calibration for three opto/fluid connectors/illuminators T1, T2 and T3 providing different methods of delivering excitation energy to the fluorophore molecules, with each data point averaged over three runs with two cycles per run. T1 leads to direct excitation by means of the leaky optical modes in the liquid core region. T3 leads to evanescent wave excitation which arises due to the guided optical modes in the wall of the capillary. T2 provides a combination of both methods of excitation. FIGS. 11 and 12 show an T1 OFC and T3 OFC, respectively.

The error bars represent the variation in the normalized value over the three runs and two cycles per run, error bars smaller than the size of the symbol are not visible. The data has been further normalized by subtracting the average value of the normalized buffer for each of the illuminators. The graphs show a linear dependence between target concentration and normalized fluorescent intensity, allowing extraction of molecular concentration from the normalized fluorescence data taken at different times. As the error in concentration estimates decreases with increasing slope sensitivity, the T1 illuminator will give the smallest error in estimating concentration from the measured normalized value of fluorescent intensity. However, these graphs do not show that the opto/fluid connector 210 has two serious flaws: 1) extended exposure of the fiber surface to the fluid stream ultimately leads to failure of the opto/fluid connector; and 2) the problems associated with micro-bubbles are more probable. The significance of bubbles in capillary systems has been discussed by Wang et al. [J. Chromatogr. A. 1062 (2005) 274]. In the preferred embodiment of the CWB of the present invention, the T3 illuminator was found to be a better choice for extended use and provided reliable estimates of concentration from data taken at different times.

In a preferred embodiment of the present invention, hybridization and detection of target i s performed for natural samples, using protocols designed to detect unlabeled natural targets. e.g. by capturing the targets with a specific probe and subsequently labeling them with a non-specific fluorescently-tagged secondary probe (i.e. complementary hybridization). In laboratory tests direct hybridization of a pre-labeled target to a surface-mounted probe was employed. A capillary coated with a DNA probe sequence is exposed to a solution containing a synthetic target with a complementary DNA sequence, tagged with fluorescent dye molecules. Adjustment of hybridization time and temperature will modify the dynamics of detection, typically 2 to 30 minutes at 35° C. to 60° C. At the end of the hybridization cycle the target solution is replaced by hybridization buffer and the measured fluorescent intensity indicates the number of target molecules that bound to the immobilized probe. The capillary can be reused by removing the bound target through the denaturing step.

Capillary preparation in a preferred embodiment of the present invention is performed by immobilized synthesized probe DNA on the interior surface of silica capillary tubes using the method of Kumar et al. [See, Kumar, et al., Nucleic Acids Res. 28 (2000) e71.] The silanized probe, obtained by reacting 3-mercaptopropyl)-trimethoxysilane with a 5’-thiol-labeled oligonucleotide probe (Oligos Etc., Inc., Wilsonville, Oreg.) in acetate buffer, was covalently attached to a NaOH-activated glass surface. The method was modified for use with capillaries (i.e., solutions were injected into capillaries and drying times were lengthened as needed). Kumar's method leads to a streamlined procedure for rapidly preparing coated capillary tubes.

A EUB338 sequence, which targets 16s ribosomal RNA of the phylogenetic domain Bacteria, was used for the probe. A complementary target sequence, labeled with the fluorochrome Alexa-532 (Molecular Probes, Eugene, Oreg.) was also purchased (Oligos Etc.) to test the biosensor's stability and responsiveness.

In a preferred embodiment of the present invention, hybridization and target concentration were performed as follows. Hybridization and denaturing measurements were performed at 40° C. using probe-coated capillaries. Typically, the capillary was loaded with the (nonfluorescent) hybridization buffer solution and allowed to equilibrate for two minutes before acquiring data, to ensure settling of micro-flows in the capillary. Fluorescence readings were recorded at one second intervals for one minute.

This procedure was repeated with several rinses of hybridization buffer until a stable baseline reading was achieved. A solution of fluorochrome-labeled target molecules in hybridization buffer was then injected. A ten-minute hybridization time was typically used, in which target molecules bound to probe molecules immobilized on the interior capillary cell wall. The capillary was flushed with 5 ml buffer to remove unhybridized fluorescent probe, and reloaded with fresh buffer solution for fluorescence measurements. Following measurement, the hybridized target molecules were stripped from the probe molecules by filling the capillary with a denaturing solution (1:1 volume ratio of formamide and hybridization buffer) at 40° C. for 2 minutes. The capillary was then flushed, refilled with hybridization buffer, and the background fluorescence signal recorded.

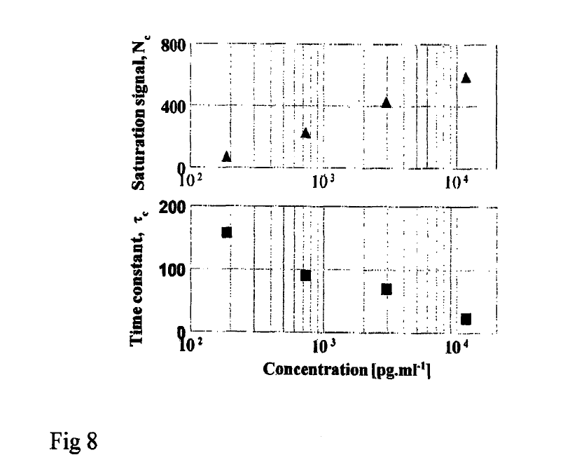

FIG. 8 shows a summary of the rate of hybridization for several target concentrations. In all cases the sensor signal reaches a saturation level which is dependent on the target concentration. The underlying kinetics of hybridization, particularly for nuclei acids immobilized on a solid surface, are not well understood. [See, Erickson, et al., Anal. Biochem. 317 (2003) 186.] Given the abundance of probe in the immobilized state one might have expected all target concentration to eventually reach the same saturation level; this does not appear to be the case. Interestingly, Ahn, et al reported a very similar relationship for another type of biosensor.

The CWB response at concentration c can be modeled by a saturation value N_{c} and an equilibrium time constant τ_{c}, described by an exponential function, as in Equation (7):

N_{F}(t)=N_{c}[1−exp(t/τ_{c})] (7)

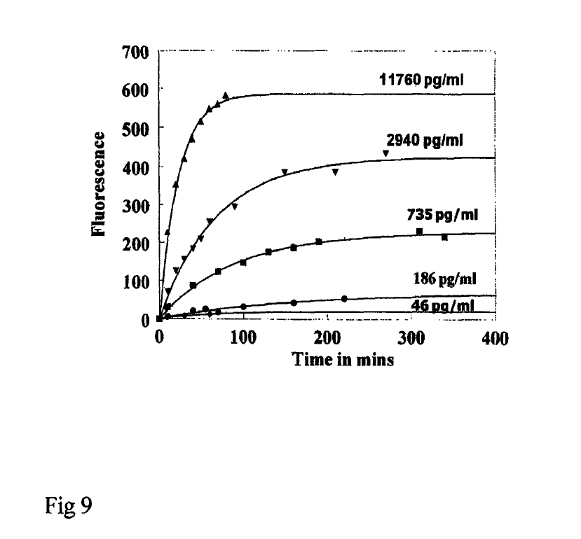

The solid lines in FIG. 8 show the results of a least squares curve fitting to the data using equation (7). From the fit parameters N_{c} and τ_{c} can be extracted and these are plotted in FIG. 9 as a function of concentration. The top panel in FIG. 9 shows that the saturation value is proportional to the log of the concentration. The lower panel shows the expected monotonically decreasing relationship between the equilibrium time constant and the target concentration.

The present invention demonstrates that Rayleigh scattering is an acceptable indicator of perturbations taking place in the micro-sensing environment of fluorescence based sensors. Instantaneous normalization of the fluorescent signal by the Rayleigh scattering background has proven to be an effective technique for enhancing the efficacy of these sensors. In particular, a capillary waveguide biosensor using dual detectors provided consistent detection and quantification of the concentration of microbial targets in natural samples.

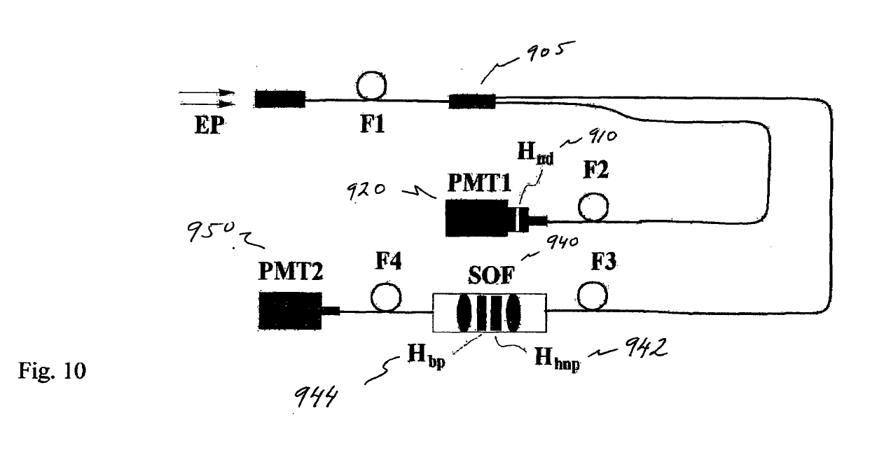

FIG. 10 shows a dual photomultiplier scheme for fluorescent detection of the present invention. As shown in FIG. 10, an emitted photon stream (EP) received from a sample volume is input to fiber optic power splitter 905. A neutral density filter H_{nd} 910 filters the photon stream input to a first photomultiplier 920. One millimeter fibers (F1, F2, F3) guide the photon stream, and a spectral optical filter unit 940, including band pass filter 942 and holographic notch plus filter 944, filter the photon stream input to a second photomultiplier 950.

While the invention has been shown and described with reference to certain exemplary embodiments of the present invention thereof, it will he understood by those skilled in the art that various changes in form and details may be made therein without departing from the spirit and scope of the present invention as defined by the appended claims and equivalents thereof.

What is claimed is:

1. A method for improved reproducibility for determining sample solute concentration, the method comprising:
utilizing a first photomultiplier (PMT) to measure instantaneous fluorescent activity of a sensing volume;
utilizing a second PMT to measure instantaneous Rayleigh scattering background from the same sensing volume; and
combining outputs of the first and second PMTs to yield a real-time normalization of fluorescent counts.

2. The method of claim 1, wherein the normalization of fluorescent counts is used to predict absolute concentrations of fluorescent solutes.

3. The method of claim 1, wherein the normalized fluorescent counts are used to quantify a false target detection probability threat.

4. The method of claim 1, wherein the method of claim 1 is utilized in a reusable capillary waveguide sensor.

5. The method of claim 1, wherein the method of claim 1 provides one of detection and quantification of bacteria targets extracted from marine samples, environmental monitoring, forensic analysis, retrovirus detection, genetic disorder diagnosis, cancer diagnosis and microbiological analysis of foods.

6. The method of claim 1, wherein outputs of the first and second PMTs are combined using equation:
$${N}_{F} ( t ) = \frac{〈 {n}_{F} ( t ) 〉}{〈 {n}_{R} ( t ) 〉} = \frac{1}{τ} [ {ɛφ}_{o} {\int }_{λ} Q ( λ ) T ( λ ) s ( λ ) d λ ] c$$
to yield an instantaneous normalization of fluorescent counts.

7. A capillary waveguide biosensor comprising:
an optical excitation and detection part for detection of nucleic acid hybridization within a reusable capillary waveguide biosensor;
a fluid control part; and
an electronics module that includes first and second photomultipliers, wherein the first photomultiplier measures a time average of fluorescent activity and the second photomultiplier measures Rayleigh scattering background photon counts.

8. The biosensor of claim 7, wherein outputs of the first and second photomultipliers are combined to yield a real-time normalization of fluorescent counts.

9. The biosensor of claim 7, wherein the reusable capillary waveguide biosensor is denaturing with formamide.

10. The biosensor of claim 7, wherein the fluid control part includes:
a fluid sample waste port;
a fluid port for a denaturing solution;
a sample/buffer port;
a multi-directional pinch valve;
isolation valves;
a micro-pump;
resistance thermistors; and
an opto/fluid connector.

11. The biosensor of claim 10, wherein the sample/buffer port is connected to a carousel dip probe.

12. The biosensor of claim 11, wherein the probe is bound to an inside surface of the capillary.

13. The biosensor of claim 7, wherein the electronics module further includes:
an illuminating optical fiber;
an emission pick-up fiber;
a power splitter;
a neutral density filter;
a laser diode; and
a plurality of photomultipliers.

14. A fluorescence detection method for solute concentration estimate, the method comprising:
detecting, using two fluorescence-based hybridization sensors, target sequences via hybridization of the solute with surface-bound probe molecules.

15. The fluorescence detection method of claim 15, wherein the probe molecules are bound to a surface of a reusable capillary probe.

16. The fluorescence detection method of claim 15, wherein the method is utilized in a biological sensing apparatus.

17. The fluorescence detection method of claim 16, wherein the apparatus is a portable apparatus used for detection of a chemical species.

18. The fluorescence detection method of claim 16, wherein the apparatus is a portable apparatus used for detection of a bacterial species.
